(19) United States
(12) Patent Application Publication
(10) Pub. No.: US 2015/0280616 A1
(43) Pub. Date: Oct. 1, 2015

(54) POWER-GENERATING VIBRATION SENSOR, AND TIRE AND ELECTRICAL DEVICE USING THE SAME

(71) Applicant: Panasonic Intellectual Property Management Co., Ltd., Osaka (JP)

(72) Inventors: YASUYUKI NAITO, Osaka (JP); KEIJI ONISHI, Osaka (JP)

(21) Appl. No.: 14/736,602

(22) Filed: Jun. 11, 2015

Related U.S. Application Data
(63) Continuation of application No. PCT/JP2014/002581, filed on May 16, 2014.

(30) Foreign Application Priority Data
May 17, 2013 (JP) 2013-105476

(51) Int. Cl. H02N 2/18; G01H 11/08; H02N 1/10

(52) U.S. Cl. CPC H02N 2/186; H02N 1/10; G01H 11/08

(57) ABSTRACT

A power-generating vibration sensor according to the present disclosure includes a power generation device that converts vibration into power and outputs vibration information, a first power system that extracts the output vibration information, and a second power system that is connected to the power generation device and supplies the power to a transmitter for transmitting the vibration information extracted by the first power system.

### BACKGROUND

1. Technical Field

The present disclosure relates to a power-generating vibration sensor, and particularly to a vibration sensor that generates power by an external force and detects vibration, and a tire and an electrical device that use the same.

2. Description of the Related Art

In various electrical devices and the like, physical quantity sensors, such as a pressure sensor, an acceleration sensor, and a strain sensor, are currently used.

In particular, attempts are being made to acquire various pieces of information on the basis of acceleration detected in mobile phones, vehicles, and sensor devices capable of performing such acceleration detection are required. Such a sensor device is provided in a narrow space in an electrical device, and therefore required to be reduced in size and save space. In addition, mobile phones and the like are required to operate for as long as possible on a single charge, a sensor device in vehicles and the like is used in a space to which it is difficult to supply power, and thus sensor devices are required to reduce their power consumption. Furthermore, a portion in which these physical quantity sensors are mounted is away from a portion in which control, such as feedback control, is performed using their sensing information, and, in some cases, a wireless device has to transmit sensing information from a physical quantity sensor to a device, such as a control device. In a sensor device including such a wireless device, not only a sensing section (sensor section) but also a wireless machine is required to operate on lower power.

Now, MEMS devices (MEMS: Micro Electro Mechanical Systems) are practically used in many fields, such as wireless, optics, motion sensing, biotechnology, and power generation. As devices obtained by applying a MEMS technology to a power generation field among them, Energy Harvesters that collect and utilize energy in the environment as light, heat and vibration have been developed. Such an energy harvester is used in, for example, a power supply of the above-mentioned low-power wireless machine, thereby enabling a wireless sensor network not to require a power supply cable or a battery. In addition, the MEMS technology is applied to energy harvesters, and the energy harvesters are thereby expected to be reduced in size.

In addition to the MEMS devices, piezoelectric devices can also be used as energy harvesters, thereby enabling wireless sensor networks not to require a power supply cable or a battery. Furthermore, the piezoelectric devices can be reduced in size as in the MEMS devices, such miniaturized piezoelectric devices are used in the energy harvesters, and the energy harvesters are thereby expected to be reduced in size as in the above.

As an example of a sensor device including a wireless device (wireless sensor network), a tire sensor system in a vehicle is given. The tire sensor system is a system that includes a wireless sensor installed in the vicinity of a tire, such as a tire or wheel, monitors a tire or road surface condition, such as an air pressure of the tire or a frictional force between the tire and a road surface, by using detected physical information, and thereby performs safety control of the vehicle. The physical information here denotes the air pressure of the tire, information of vibration from the road surface, and so forth.

In the environment surrounding the tire in which the amounts of light dissipation and heat dissipation are relatively small, a vibration power generator that generates power by causing members which constitute a device to vibrate by utilizing a force applied from an external environment is useful. The types of vibration power generators include a piezoelectric type, an electromagnetic type, and an electrostatic type.

An example of a technology related to such a tire sensor system is a technology disclosed in Japanese Unexamined Patent Application Publication No. 2005-22457. A tire monitoring device (tire sensor system) includes, as essential components, sensors (physical quantity sensors) that detect physical quantities obtained from a tire, and a power generator that supplies power to wireless devices included in these sensors.

### SUMMARY

However, the above-mentioned existing power-generating vibration sensors have not achieved sufficient reductions in power consumption and size.

One non-limiting and exemplary embodiment provides a power-generating vibration sensor that enables reductions in power consumption and size.

In one general aspect, the techniques disclosed here feature a power-generating vibration sensor according to an aspect of the present disclosure includes a power generation device that converts vibration into power and outputs vibration information, a first power system that extracts the output vibration information, and a second power system that is connected to the power generation device and supplies the power to a transmitter for transmitting the vibration information extracted by the first power system.

It should be noted that general or specific embodiments may be implemented as a system, a method, an integrated circuit, a computer program, a storage medium such as a computer readable compact disk ROM (CD-ROM), or any selective combination thereof.

The present disclosure can provide a power-generating vibration sensor that enables reductions in power consumption and size. Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 includes schematic views illustrating the structure of a tire sensor system according to a first embodiment; FIG. 1(a) illustrates a state in which a power-generating vibration sensor reaches the ground, and FIG. 1(b) illustrates a state in which the power-generating vibration sensor moves away from the ground;

FIG. 2 is a block diagram illustrating the structure of the tire sensor system according to the first embodiment;

FIG. 3 is a block diagram illustrating the structure of a transmitter according to the first embodiment;

FIG. 4 includes cross-sectional views illustrating the power-generating vibration sensor according to the first embodiment; FIG. 4(a) illustrates a state in which a movable substrate is not displaced relative to a fixed substrate, and FIG. 4(b) illustrates a state in which the movable substrate is displaced to the right relative to the fixed substrate;

FIG. 5 illustrates the relationship between the arrangement of first electrodes and second electrodes according to an aspect of the power-generating vibration sensor according to the first embodiment and a vibration direction of the movable substrate;

FIG. 6 illustrates the relationship between the arrangement of the first electrodes and the second electrodes according to another aspect of the power-generating vibration sensor according to the first embodiment and the vibration direction of the movable substrate;

FIG. 7 is a cross-sectional view illustrating a power-generating vibration sensor according to a second embodiment;

FIG. 8 is a top view illustrating an arrangement of stacked structures according to an aspect of the power-generating vibration sensor according to the second embodiment;

FIG. 9 is a top view illustrating an arrangement of the stacked structures according to another aspect of the power-generating vibration sensor according to the second embodiment;

FIG. 10 includes diagrams representing a power output of the power-generating vibration sensor according to a third embodiment (FIG. 10(a)) and vibration of a tire (FIG. 10(b));

FIG. 11 includes diagrams representing a power output of the power-generating vibration sensor according to the third embodiment (FIG. 11(a)) and vibration of a tire (FIG. 10(b));

FIG. 12 includes diagrams representing vibration of a tire according to a fourth embodiment;

FIG. 13 includes diagrams representing vibration of a tire according to a fifth embodiment.

### DETAILED DESCRIPTION

Embodiments of the present disclosure will be described below with reference to the accompanying drawings.

In view of the problems in the related art, the present inventors have conducted diligent investigations, and thereby have found that acceleration sensing can be performed by using a power waveform of a vibration power generator traditionally used for only supplying power to devices, such as a wireless device and so forth, constituting a sensor device, that is, a power waveform generated when the vibration power generator is subjected to vibration. In particular, there has been obtained the finding that such acceleration sensing can be suitably used in transportation devices, such as a vehicle and a motorcycle, in particular in the tires of these transportation devices, and the case where the vibration power generator is mounted on a tire of a transportation device, such as a vehicle or motorcycle, will therefore be described below. The present inventors have conducted further investigations on the basis of the finding, and thereby have found that, when a first power system and a second power system are provided, one power system can be used for sensing in which a tire condition or a road surface condition is estimated, and also one of other power systems is used for supply of power for transmitting information, which has been obtained by performing sensing, externally (for example, from a transmitter provided in the sensor device to a receiver provided outside the sensor device). The inventors have found that this enables omission of either a physical quantity sensor, such as a pressure sensor, acceleration sensor, or strain sensor, or power supply means that supplies power to the physical quantity sensor, and enables reductions in power consumption, size, and cost of the sensor, and the inventors have accomplished the present invention.

The present disclosure has been accomplished on the basis of the findings, and provides a power-generating vibration sensor including a power generation device that converts vibration into power and outputs vibration information, a first power system that extracts the output vibration information, and a second power system that is connected to the power generation device and supplies the power to a transmitter for transmitting the vibration information extracted by the first power system.

In addition, in the power-generating vibration sensor according to the present disclosure, two power generation devices may be included, one of them may be connected to a first power system that extracts vibration information, and the other may be connected to a second power system that supplies power for propagating the vibration information; alternatively, one power generation device may be included, and the first power system and the second power system may be connected to the power generation device.

Each embodiment will be described in detail below.

### 1. First Embodiment

<1-1. Structure>

<1-1-1. Overall Structure>

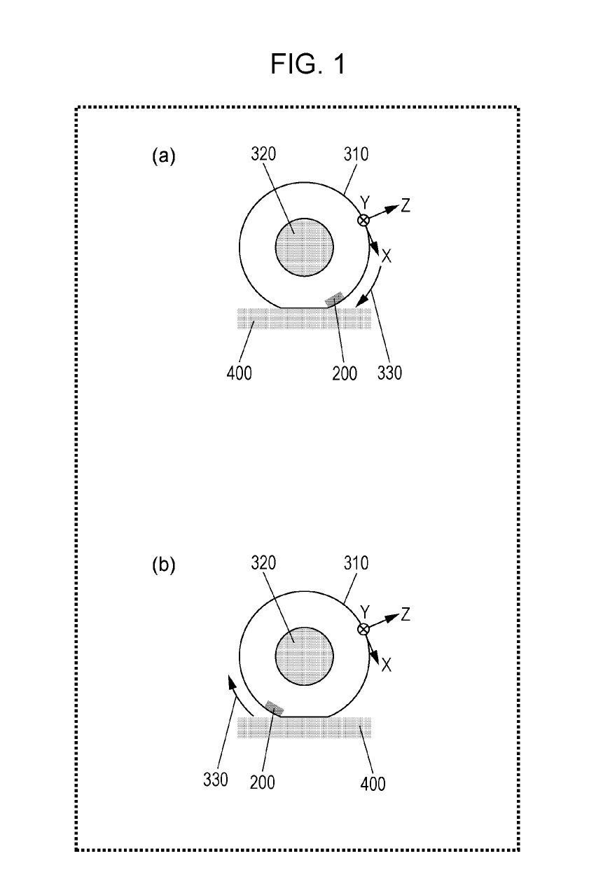

FIG. 1 includes views illustrating the structure of a tire sensor system according to the first embodiment (an example of a system using the vibration power-generating sensor of the present disclosure). As illustrated in FIG. 1, a transmitter 200 of the first embodiment is mounted inside a tire 310 mounted on a wheel 320. FIG. 1(a) illustrates a state in which the transmitter 200 rotates in a rotation direction 330 of the tire and comes into contact with a road surface 400 through a member of the tire. On the other hand, FIG. 1(b) illustrates a state in which the transmitter 200 rotates in the rotation direction 330 of the tire and moves away from the road surface 400. The transmitter 200 transmits a data signal for determining a tire or road surface condition.

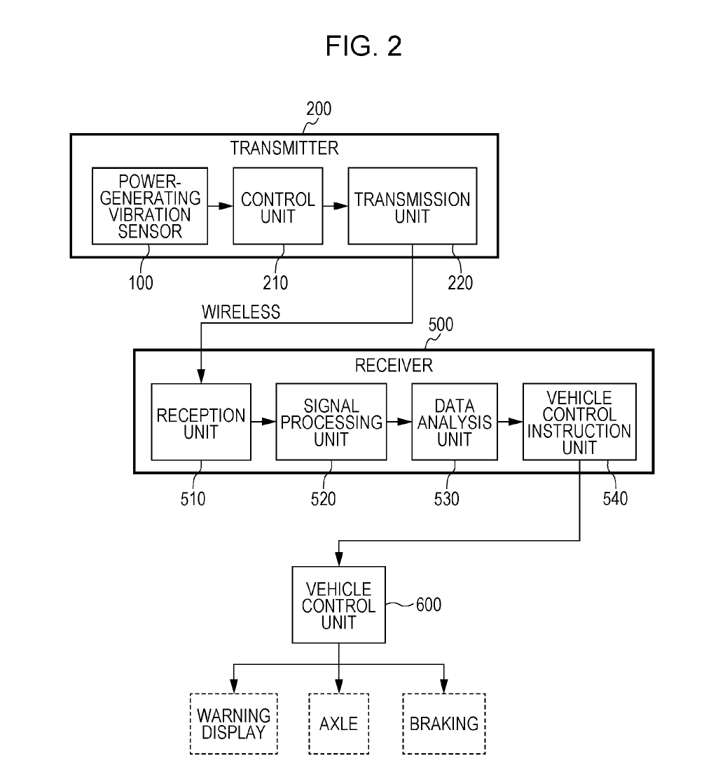

FIG. 2 is a block diagram illustrating the structure of the tire sensor system according to the first embodiment. The tire sensor system mainly includes the transmitter 200 and a receiver 500 that are used for a data signal, and a vehicle control unit 600 that controls a vehicle in accordance with a determined tire condition or road surface condition. The transmitter 200 includes a power-generating vibration sensor 100, a control unit 210, and a transmission unit 220. The power-generating vibration sensor 100 detects vibration of a tire, and transmits a data signal to the control unit 210. The control unit 210 transmits, to the transmission unit 220, the data signal and an instruction to perform data transmission. The data signal wirelessly transmitted by the transmission unit 220 is input to the receiver 500. The receiver 500 includes a reception unit 510, a signal processing unit 520, a data analysis unit 530, and a vehicle control instruction unit 540. The data signal is transmitted from the reception unit 510 to the signal processing unit 520, and is processed, through noise elimination, smoothing, or the like, into clear data appropriate to data analysis. Subsequently, the data signal processed in the signal processing unit 520 is transmitted to the data analysis unit 530. In the data analysis unit 530, a tire condition or a road surface condition is determined on the basis of a waveform of the vibration data. The vehicle control instruction unit 540 transmits an instruction to perform vehicle control based on the tire or road surface condition to the vehicle control unit 600. The vehicle control unit 600 controls warning display, an axle, and braking.

For example, in a slippery road surface condition, a warning is displayed, and a driver can be alerted. In addition, an axle and braking are controlled, and the vehicle itself can actively perform safety functions so that the vehicle does not skid and crash.

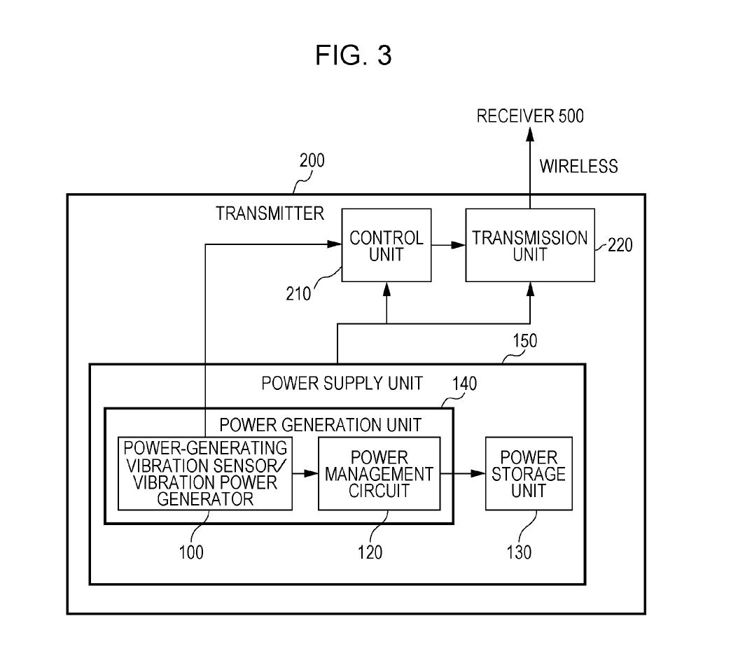

FIG. 3 is a block diagram illustrating the structure of the transmitter 200 according to the first embodiment. A first power system according to the present disclosure is a system for extracting vibration information obtained by a power generation device, and denotes a path extending from the power-generating vibration sensor/vibration power generator 100 to the transmission unit 220 through the control unit 210 in FIG. 3. In addition, a second power system of the present disclosure is a system for supplying power for externally transmitting the vibration information extracted by the first power system, and denotes a path extending from a power supply unit 150 including the power-generating vibration sensor/vibration power generator 100 to the control unit 210 or the transmission unit 220 in FIG. 3.

As illustrated in FIG. 2, the transmitter 200 includes the power-generating vibration sensor 100, the control unit 210, and the transmission unit 220. The transmitter 200 of the first embodiment can use, as a power source for driving the control unit 210 and the transmission unit 220, that is, as a power generator, the power-generating vibration sensor 100 that converts external vibration energy into power (hereinafter, it may be referred to as a power-generating vibration sensor 100 when used for sensing, may be referred to as a vibration power generator 100 when used as a power generator, and also may be referred to as a power-generating vibration sensor/vibration power generator 100 when used both for sensing and as a power generator). The power-generating vibration sensor 100 outputs a voltage corresponding to a waveform of external vibration, and therefore constitutes a power generation unit 140 together with a power management circuit 120 that performs conversion into a direct-current voltage. The power supply unit 150 supplies power from the power generation unit 140 to the control unit 210 and the transmission unit 220. Furthermore, the power supply unit 150 includes a power storage unit 130 in addition to the power generation unit 140, and can supply power from the power storage unit 130 to the control unit 210 and the transmission unit 220 as appropriate.

In the present structure, vibration information is extracted by using a power output waveform of the power-generating vibration sensor 100, thereby enabling the vibration power generator to function as a vibration sensor. A vibration sensor, such as an acceleration sensor, becomes unnecessary, and the number of components can be reduced to thereby simplify the structure. Reductions in power consumption, size, and cost of the transmitter 200 can be achieved.

In addition, as illustrated in FIG. 2, the transmitter 200 does not include the signal processing unit 520, the data analysis unit 530, and vehicle control instruction unit 540 that are included in the receiver 500, and thus power consumption in the transmitter 200 can be reduced.

Furthermore, in the case where noise or a transmission error caused by wireless transmission occurs and the quality of a data signal is not acceptable, or in the case where power consumption is acceptable in the transmitter 200, the transmitter 200 may include component blocks of the receiver 500.

<1-1-2. Structure of Power-Generating Vibration Sensor>

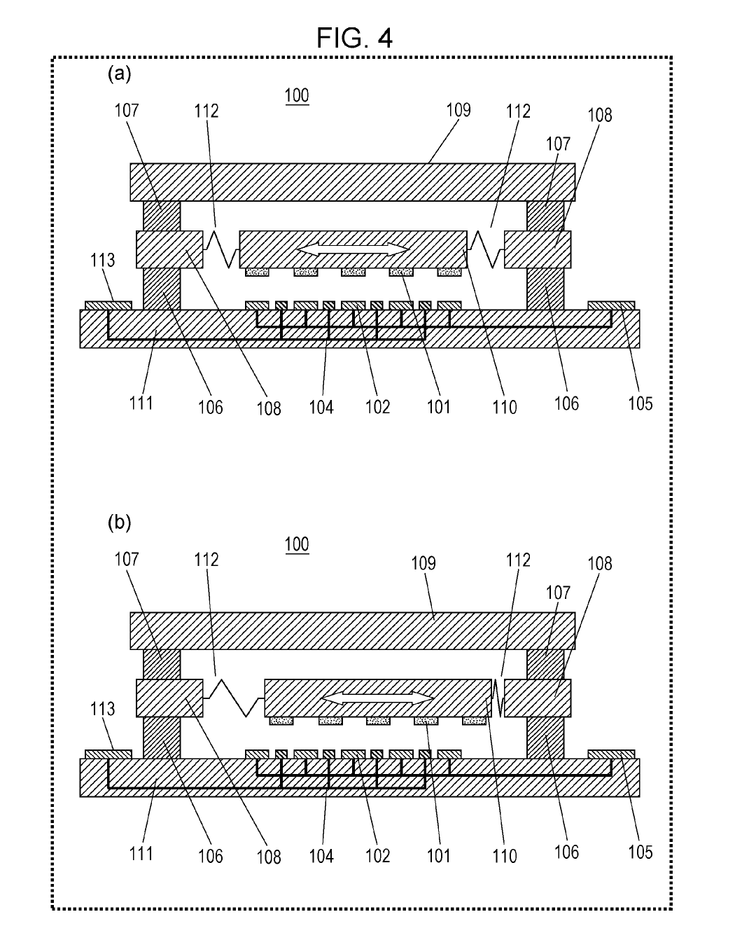

The structure of the power-generating vibration sensor 100 will be described with reference to FIG. 4. The first power system according to the present disclosure denotes a path connected to a first pad 105, which will be described later, in FIG. 4, and the second power system according to the present disclosure denotes a path connected to a second pad 113, which will be described later, in FIG. 4. As described later, the power-generating vibration sensor 100 includes a movable substrate (a movable component, weight, or vibrating body) 110 that vibrates therein. FIG. 4(a) illustrates a state in which the movable substrate 110 is at a center of vibration. FIG. 4(b) illustrates a state in which the movable substrate 110 is displaced from the center of vibration to the right.

The power-generating vibration sensor 100 includes a lower substrate (first substrate) 111, an upper substrate (second substrate) 109, the movable substrate (hereinafter, it may be referred to as a movable component, weight, or vibrating body) 110, springs (elastic structures) 112, fixed structures 108, upper junctions 107, lower junctions 106, a plurality of electrets 101, a plurality of first electrodes 102, a plurality of second electrodes 104, the first pad 105, and the second pad 113.

The upper substrate 109 and the lower substrate 111 are arranged so as to face each other in parallel. The upper substrate 109 and the lower substrate 111 are provided at a certain distance from the movable substrate 110, the springs 112, and the fixed structures (intermediate substrate) 108, and are fixed with the upper junctions 107 and the lower junctions 106.

As illustrated in FIG. 4, the fixed structures 108, the movable substrate 110, and the springs 112 are formed by processing one substrate. Thus, the fixed structures 108, the movable substrate 110, and the springs 112 may be referred to as “the intermediate substrate 108 to which the movable substrate 110 is connected using the elastic structures 112”, or “the intermediate substrate 108 having the weight 110 which can be moved by the elastic structures 112”.

The movable substrate 110 is provided so as to be movable in at least one axis direction (for example, a double-headed arrow direction in FIG. 4) parallel to the upper substrate 109 or the lower substrate 111. Thus, the movable substrate 110 follows an externally-applied force (vibration), and can vibrate (reciprocate) in a direction parallel to the upper substrate 109 as illustrated in FIG. 4(b).

A surface of the upper substrate 109 facing the lower substrate 111 is referred to as a lower surface. A surface of the lower substrate 111 facing the upper substrate 109 is referred to as an upper surface.

The plurality of first electrodes 102 and the plurality of second electrodes 104 are provided on the upper surface of the lower substrate 111. The first electrodes 102 and the second electrodes 104 are arranged in an alternating manner. A line that connects the plurality of first electrodes 102 is connected to the first pad 105 through the vicinity of the upper surface inside the lower substrate 111. In addition, a line that connects the plurality of second electrodes 104 is connected to the second pad 113 through the vicinity of a lower surface inside the lower substrate 111. The first pad 105 is electrically isolated from the second pad 113. The power-generating vibration sensor 100 outputs generated power through each of the first pad 105 and the second pad 113.

The plurality of electrets 101 are provided on a surface of the upper substrate 109 on the side facing the lower substrate 111. An electret is a material that can be charged and store electrical charges. The individual electrets 101 are provided so that electric lines of force are perpendicular to the upper surface of the lower substrate 111 and are directed from the movable substrate 110 toward the lower substrate 111.

The lower substrate 111 and the fixed structures 108 are joined by the lower junctions 106 so that a certain space is provided between the first electrodes 102 and the electrets 101.

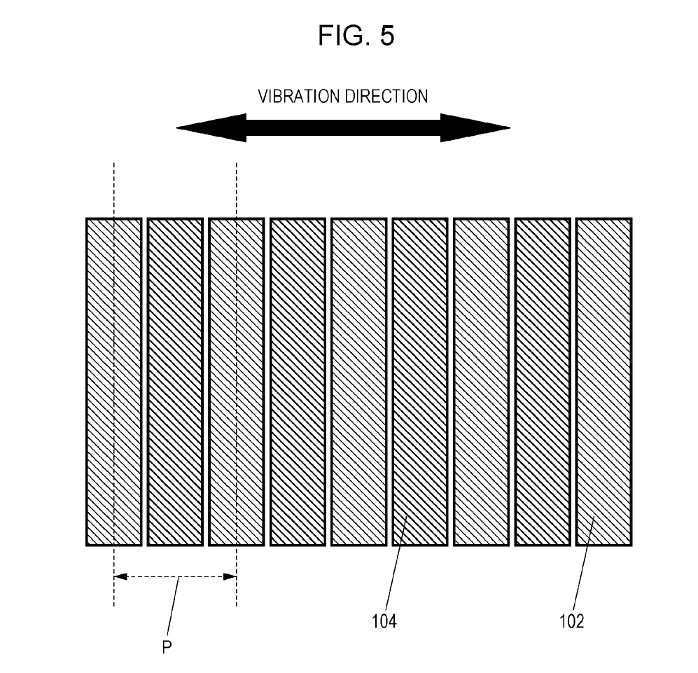

The arrangement of the first electrodes 102, 104, and the electrets 101 will be described below on the basis of FIG. 5. FIG. 5 is a view of the upper surface of the lower substrate 111 when viewed from a direction perpendicular to the upper surface of the lower substrate 111. A double-headed arrow in FIG. 5 denotes a direction in which the movable substrate 110 can vibrate.

As illustrated in FIG. 5, the first electrodes 102 and the second electrodes 104 are arranged so as to be oriented in a direction perpendicular to a direction in which the movable substrate 110 (not illustrated in FIG. 5) can vibrate and in a direction parallel to the upper surface of the lower substrate 111. P in FIG. 5 denotes a distance between the center lines of two first electrodes 102 arranged on both sides of a second electrode 104 so as to be adjacent to the second electrode 104. The plurality of first electrodes 102 are arranged so as to be parallel to each other and at equal distances using the distance P between center lines. Each second electrode 104 is arranged between two first electrodes 102 so as to be parallel to the first electrodes 102. For example, the widths (dimensions in the direction in which the movable substrate 110 can vibrate) of the first electrodes 102 and the second electrodes 104 are each preferably 50 μm to 500 μm, and more preferably about 100 μm. Such settings are set, thereby enabling many first electrodes 102 and second electrodes 104 to be formed in a limited region and making it possible to increase power output and sensing sensitivity. When both of the widths of each first electrode 102 and each second electrode 104 are 100 μm, the distance P is 200 μm.

The plurality of electrets 101 are arranged on a main surface, on the lower substrate 111 side, of two main surfaces of the movable substrate 110 so as to coincide with the first electrodes 102 when viewed from the direction perpendicular to the upper surface of the lower substrate 111. That is, the electrets 101 have the same size as the first electrodes 102, and are arranged at distances equal to the distance P between the first electrodes 102. In addition, the width of each electret 101 may be different from the width of each first electrode 102. In this case, the electrets 101 are arranged at the same distances P between center lines so that the center lines of the electrets 101 coincide with the center lines of the first electrodes 102. Because of such an arrangement, the electrets 101 are symmetrically displaced with respect to their center lines, and current and voltage waveforms in which positive and negative peaks are symmetrical and which are less disturbed can be obtained. Signal processing of output can readily be performed.

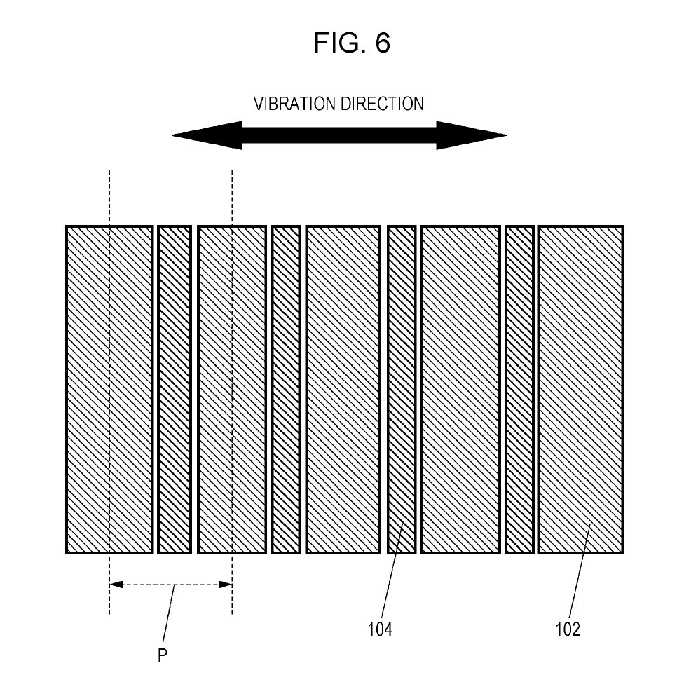

Furthermore, as illustrated in FIG. 6, the first electrodes 102 used for power generation may be formed larger than the second electrodes 104 used for sensing in which a tire condition or a road surface condition is grasped (for example, the lengths of the first electrodes 102 and the second electrodes 104 in a width direction of the movable substrate 110 may be fixed, and the lengths of the first electrodes 102 in the vibration direction of the movable substrate 110 may be larger than the lengths of the second electrodes 104 in the same direction). Such a structure enables an increase in power output obtained from the first electrodes 102.

In an aspect illustrated in FIG. 6, the widths of the first electrodes 102 preferably range from 100 μm to 500 μm, and more preferably from 100 μm to 300 μm. In addition, the widths of the second electrodes 104 preferably range from 50 μm to 200 μm, and more preferably from 50 μm to 100 μm. Such settings are set, thereby enabling many first electrodes 102 and second electrodes 104 to be formed in a limited region and making it possible to increase power output and sensing sensitivity.

<1-2. Operation performed by Power-Generating Vibration Sensor>

Referring back to FIG. 4, an operation performed by the power-generating vibration sensor 100 will be described. In the power-generating vibration sensor 100, the movable substrate 110 follows a force (for example, vibration) applied from an external environment, and vibrates in a horizontal direction. Spring constants and resonance frequencies of the elastic structures 112 are optimized so that a maximum amplitude occurs with respect to a vibration frequency of a supposed external environment (for example, vibration of a moving vehicle).

When the movable substrate 110 vibrates, a state in which facing areas of the electrets 101 and the first electrodes 102 reach their maxima as illustrated in FIG. 4(a) and a state in which the facing areas of the electrets 101 and the first electrodes 102 are reduced as illustrated in FIG. 4(b) are repeated alternately.

As the facing areas of the electrets 101 and the first electrodes 102 increase, since electric lines of force of the electrets 101 are directed from the movable substrate 110 toward the lower substrate 111, electrical charges drawn to the first electrodes 102 increase in number (supply of electricity). On the other hand, as the facing areas are reduced, electrical charges drawn to the first electrodes 102 are reduced in number, that is, released electrical charges increase in number (discharge of electricity). Thus, as the facing areas of the electrets 101 and the first electrodes 102 increase, electrostatic capacitance values between the electrets 101 and the first electrodes 102 increase, and as the facing areas are reduced, the electrostatic capacitance values are reduced.

The facing areas of the electrets 101 and the first electrodes 102 increase, the electrical charges are drawn to the first electrodes 102, and current thereby flows from the first pad 105 to the power management circuit 120. On the other hand, electrons drawn to the first electrodes 102 are released by reductions in these facing areas, and thus current flows from the power management circuit 120 to the first pad 105. Through such a power generation operation, alternating-current power is generated. The same also applies to the electrets 101 and the second electrodes 104, and current flows back and forth between the second electrodes 104 and the power management circuit 120 through the second pad 113 in accordance with vibration of the movable substrate 110. Through such an operation performed by the power-generating vibration sensor 100, alternating-current power is generated.

At this time, alternating-current power output from the first pad 105 is the same as that output from the second pad 113 in terms of change transition. That is, when the alternating-current power from the first pad 105 increases, the alternating-current power from the second pad 113 increases. The same also applies in the case of a reduction in alternating-current power. The alternating-current power from the first pad 105 and the alternating-current power from the second pad 113 change synchronously with each other.

The power management circuit 120 converts the alternating-current power output through the first pad 105 of the power-generating vibration sensor 100 into direct-current power, and outputs it.

On the other hand, the alternating-current power output through the second pad 113 of the power-generating vibration sensor 100 is input to the control unit 210 as a data signal of vibration.

<1-3. Modification>

In a modification of the first embodiment, either the first electrodes 102 or the second electrodes 104 may be arranged on the lower substrate 111, and the first power system and the second power system may be connected to those electrodes. Furthermore, one power system may be connected to those electrodes, and the one power system may branch into one or more first power systems and one or more second power systems. Such structures can make the structure of the power-generating vibration sensor simpler. The first electrodes 102 or second electrodes 104 provided on the lower substrate 111 are provided at equal distances in the direction perpendicular to the vibration direction of the movable substrate 110.

In addition, either the first electrodes 102 or the second electrodes 104 may be arranged on the lower substrate 111, and one power system may be connected to those electrodes. After the one power system performs sensing, the one power system may also generate power. Furthermore, after the one power system generates power, the one power system may also perform sensing.

<1-4. Summary of Present Embodiment>

As described above, the transmitter 200 of this present embodiment includes the power-generating vibration sensor 100 that is subjected to vibration, generates power, and detects vibration, the control unit 210 that controls signal transmission of vibration data, and the transmission unit 220. The power-generating vibration sensor 100 outputs power with the first electrodes 102 and the second electrodes 104, the power management circuit 120 converts output from the first electrodes 102 of the power-generating vibration sensor 100 into other power, and the control unit 210 controls signal transmission of vibration data on the basis of output from the second electrodes 104 of the power-generating vibration sensor 100.

In addition, in the case where an outer surface of the power-generating vibration sensor 100, which has a larger area, (for example, an outer surface of the lower substrate 111 or the upper substrate 109 in FIG. 4) is mounted in parallel to the underside of the tire 310, and is fixed firmly and stably, a tangential direction X of the round tire 310 illustrated in FIG. 1 can be made to coincide with the vibration direction of the movable substrate 110 of the power-generating vibration sensor 100 illustrated in FIG. 4 (for example, the double-headed arrow direction in FIG. 4), and thus vibration in the X direction can be efficiently utilized.

In the present structure, vibration information is extracted by using a power output waveform of the power-generating vibration sensor 100, thereby enabling the vibration power generator to function as a vibration sensor. A vibration sensor, such as an acceleration sensor, becomes unnecessary, and the number of components can be reduced to thereby simplify the structure. Reductions in power consumption, size, and cost of the transmitter 200 can be achieved.

In addition, highly-reliable mounting of the power-generating vibration sensor 100 on the tire 310, efficient power generation, and highly-sensitive vibration detection can be achieved.

### 2. Second Embodiment

The second embodiment of the present disclosure will be described below.

<2-1. Structure and Operation>

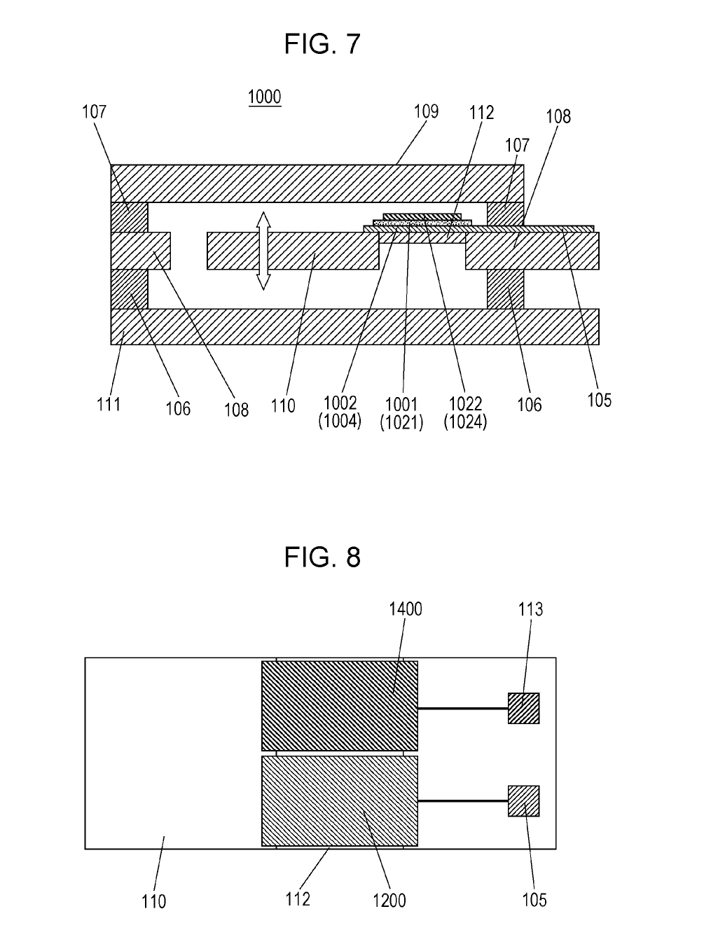

The second embodiment has the structure illustrated in FIG. 7. A power-generating vibration sensor 1000 of the second embodiment differs from the power-generating vibration sensor 100 of the first embodiment in that the power-generating vibration sensor 100 of the first embodiment generates power using electrets, whereas the power-generating vibration sensor 1000 of the second embodiment generates power using piezoelectric bodies. Except for the above, the structure is the same as that in the first embodiment.

The structure of the power-generating vibration sensor 1000 will be described with reference to FIG. 7. As described later, the power-generating vibration sensor 1000 includes the movable substrate 110 that vibrates therein.

The power-generating vibration sensor 1000 includes the lower substrate (first substrate) 111, the upper substrate (second substrate) 109, the movable substrate (hereinafter, it may be referred to as a movable component, weight, or vibrating body) 110, a spring (elastic structure) 112, the fixed structures 108, the upper junctions 107, the lower junctions 106, a first piezoelectric body 1001, a first lower electrode 1002, a first upper electrode 1022, and the first pad 105.

The upper substrate 109 and the lower substrate 111 are arranged so as to face each other in parallel. The upper substrate 109 and the lower substrate 111 are provided at a certain distance from the movable substrate 110, the spring 112, and the fixed structures (intermediate substrate) 108, and are fixed with the upper junctions 107 and the lower junctions 106.

The fixed structures 108, the movable substrate 110, and the spring 112 are formed by processing one substrate. Thus, the fixed structures 108, the movable substrate 110, and the spring 112 may be referred to as “the intermediate substrate 108 to which the movable substrate 110 is connected using the elastic structure 112”, or “the intermediate substrate 108 having the weight 110 which can be moved by the elastic structure 112”.

The movable substrate 110 is provided so as to be movable in at least one axis direction (for example, a double-headed arrow direction in FIG. 7) perpendicular to the upper substrate 109 or the lower substrate 111. Thus, the movable substrate 110 follows an externally-applied force (vibration), and can vibrate (reciprocate) in a direction perpendicular to the upper substrate 109 as illustrated in FIG. 7.

A surface of the intermediate substrate 108 facing the upper substrate 109 is referred to as an upper surface.

The first lower electrode 1002, the first piezoelectric body 1001, and the first upper electrode 1022 are stacked on the elastic structure 112 of the intermediate substrate 108. A line connected to the first lower electrode 1002 runs over the upper surface and is connected to the first pad 105.

FIG. 8 is a view of the upper surface of the intermediate substrate 108 when viewed from a direction perpendicular to the upper surface of the intermediate substrate 108.

As illustrated in FIG. 8, a first stacked structure 1200 including the first lower electrode 1002, the first piezoelectric body 1001, and the first upper electrode 1022, and a second stacked structure 1400 including a second lower electrode 1004, a second piezoelectric body 1021, and a second upper electrode 1024 are arranged in parallel on the elastic structure 112 of the upper surface of the intermediate substrate 108. A line connected to the second lower electrode 1004 runs over the upper surface and is connected to the second pad 113. The first pad 105 is electrically isolated from the second pad 113. The power-generating vibration sensor 1000 outputs generated power through each of the first pad 105 and the second pad 113.

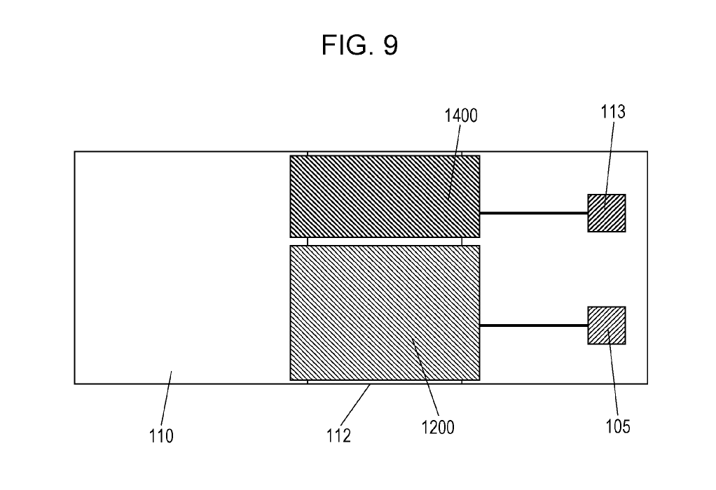

As illustrated in FIG. 8, the first stacked structure 1200 and the second stacked structure 1400 may have the same area, and, as illustrated in FIG. 9, the first stacked structure 1200 may be formed larger than the second stacked structure 1400. The first stacked structure 1200 is used for power generation, and the second stacked structure 1400 is used for sensing in which a tire condition or a road surface condition is grasped. As illustrated in FIG. 9, when the first stacked structure 1200 used for power generation is formed larger than the second stacked structure 1400 used for sensing, the amount of power generation is increased, thereby enabling a little vibrating motion to produce power required for sensing and the omission of the power storage unit 130 in the power supply unit 150 illustrated in FIG. 3.

Referring back to FIG. 7, an operation performed by the power-generating vibration sensor 1000 will be described. In the power-generating vibration sensor 1000, the movable substrate 110 follows a force (for example, vibration) applied from an external environment, and vibrates. A spring constant and a resonance frequency of the elastic structure 112 are optimized so that a maximum amplitude occurs with respect to a vibration frequency of a supposed external environment (for example, vibration of a moving vehicle).

When the movable substrate 110 vibrates, the first piezoelectric body 1001 and the second piezoelectric body 1021 are deformed in accordance with the deformation of the elastic structure 112. Since a piezoelectric body is deformed to thereby generate voltage, up-and-down vibration in a direction perpendicular to an upper surface of the upper substrate 109 is repeated, and power generation is thereby repeated alternately.

Through such an operation performed by the power-generating vibration sensor 1000, alternating-current power is generated.

At this time, alternating-current power output from the first pad 105 is the same as that output from the second pad 113 in terms of change transition. That is, when the alternating-current power from the first pad 105 increases, the alternating-current power from the second pad 113 increases. The same also applies in the case of a reduction in alternating-current power. The alternating-current power from the first pad 105 and the alternating-current power from the second pad 113 change synchronously with each other.

The power management circuit 120 converts the alternating-current power output through the first pad 105 of the power-generating vibration sensor 1000 into direct-current power, and outputs it.

On the other hand, the alternating-current power output through the second pad 113 of the power-generating vibration sensor 1000 is input to the control unit 210 as a data signal of vibration.

<2-2. Modification>

In a modification of the second embodiment, either the first stacked structure 1200 or the second stacked structure 1400 may be arranged on the elastic structure 112, and the first power system and the second power system may be connected to that stacked structure. Furthermore, one power system may be connected to that stacked structure, and the one power system may branch into one or more first power systems and one or more second power systems. Such structures can make the structure of the power-generating vibration sensor simpler.

In addition, either the first stacked structure 1200 or the second stacked structure 1400 may be arranged on the elastic structure 112, and one power system may be connected to that stacked structure. After the one power system performs sensing, the one power system may also generate power. Furthermore, after the one power system generates power, the one power system may also perform sensing.

<2-3. Summary of Present Embodiment>

As described above, in the power-generating vibration sensor 1000 of this present embodiment, in the case where an outer surface of the power-generating vibration sensor 1000, which has a larger area, (for example, an outer surface of the lower substrate 111 or the upper substrate 109 in FIG. 7) is mounted in parallel to the underside of the tire 310, and is fixed firmly and stably, a normal direction Z of the round tire 310 illustrated in FIG. 1 can be made to coincide with the vibration direction of the movable substrate 110 of the power-generating vibration sensor 1000 illustrated in FIG. 7 (for example, the double-headed arrow direction in FIG. 7), and thus vibration in the Z direction can be efficiently utilized.

In the present structure, vibration information is extracted by using a power output waveform of the power-generating vibration sensor 1000, thereby enabling the vibration power generator to function as a vibration sensor. A vibration sensor, such as an acceleration sensor, becomes unnecessary, and the number of components can be reduced to thereby simplify the structure. Reductions in power consumption, size, and cost of the transmitter 200 can be achieved.

In addition, highly-reliable mounting of the power-generating vibration sensor 1000 on the tire 310, efficient power generation, and highly-sensitive vibration detection can be achieved.

### <3. Third Embodiment>

A third embodiment of the present disclosure will be described below.

In this present embodiment, a method of analyzing vibration data obtained from the power-generating vibration sensors described in the first embodiment and the second embodiment, and a method of estimating a tire or road surface condition using the vibration data will be described.

<3-1. Vibration Data Analysis Method, and Tire or Road Surface Condition Estimation Method>

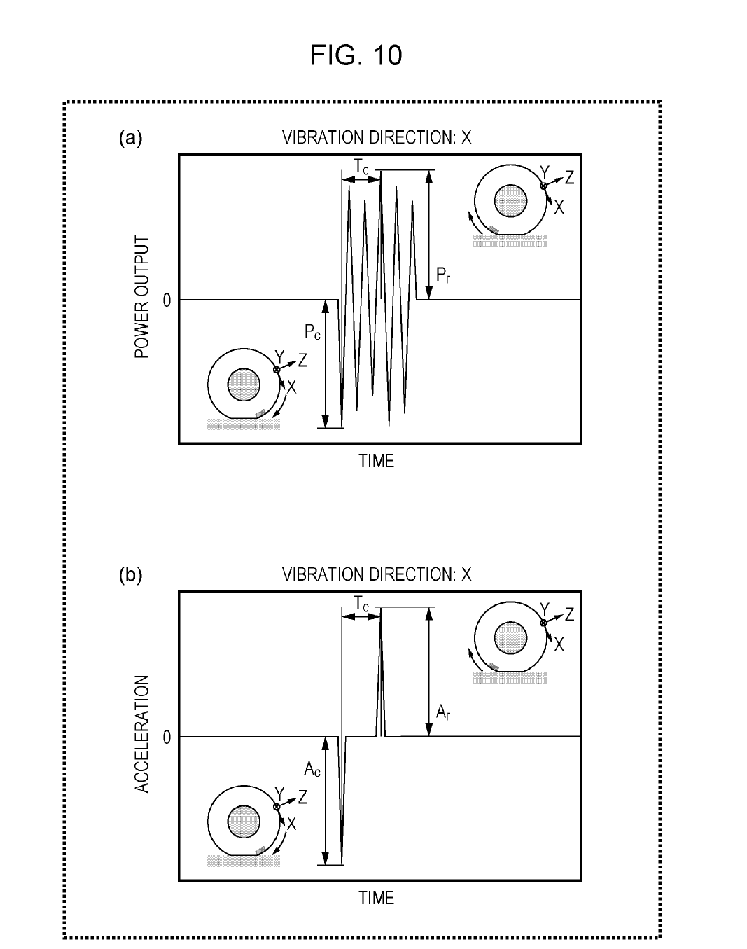

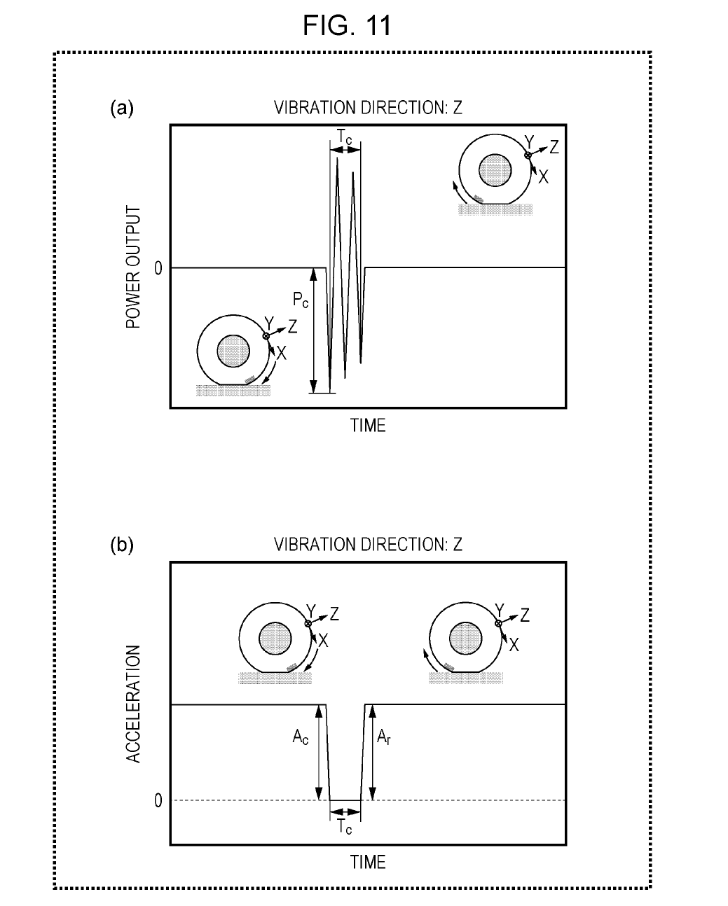

A method of conversion from a power output waveform into an external vibration waveform will be described with reference to FIG. 10 and FIG. 11. Each of the power-generating vibration sensors (vibration power generators) outputs power corresponding to a waveform of external vibration, and the waveform of external vibration can therefore be obtained by analyzing a power output waveform in the data analysis unit 530 illustrated in FIG. 2.

In FIG. 10(a), the horizontal axis represents time, and the vertical axis represents a power output based on vibration in a tangential direction X of a round tire. In FIG. 10(b), the horizontal axis represents time, and the vertical axis represents an acceleration representing the magnitude of vibration in the tangential direction X of the round tire, which is obtained from a power output illustrated in FIG. 10(a).

In a state in which the tire rotates and the power-generating vibration sensor comes into contact with a road surface through a member of the tire, a rotational speed of the power-generating vibration sensor is decelerated, and a contact acceleration A_{c} is applied. In a state in which the tire further rotates and the power-generating vibration sensor moves away from the road surface, the member of the tire is opened from the road surface, the speed of the power-generating vibration sensor is thereby accelerated, and a release acceleration Aᵣ is applied. A contact time period T_{c} denotes a time period from when this power-generating vibration sensor comes into contact with the road surface to when it moves away from the road surface.

The vibrating body of the power-generating vibration sensor is displaced due to the contact acceleration A_{c}, and performs free vibration. In this case, a contact power output P_{c} corresponding to the contact acceleration A_{c} is obtained. For example, as the contact acceleration A_{c} increases, the displacement of the vibrating body increases, and the contact power output P_{c} increases. Subsequently, the vibrating body performs free vibration again due to the release acceleration Aᵣ, and a release power output Pᵣ corresponding to the release acceleration Aᵣ is obtained.

In addition, although the contact power output P_{c} and the release power output Pᵣ are respectively denoted by a negative value and a positive value, the positive and negative values may be reversed by some definition.

The power waveform illustrated in FIG. 10(a) is acquired, the contact power output P_{c}, the release power output Pᵣ, and the contact time period T_{c} are extracted, and thus an external vibration waveform including the contact acceleration A_{c}, the release acceleration Aᵣ, and the contact time period T_{c} that are illustrated in FIG. 10(b) can be obtained.

In FIG. 11(a), the horizontal axis represents time, and the vertical axis represents a power output based on vibration in a normal direction Z of a round tire. In FIG. 11(b), the horizontal axis represents time, and the vertical axis represents an acceleration representing the magnitude of vibration in the normal direction Z of the round tire.

In a state in which the tire rotates and the power-generating vibration sensor comes into contact with a road surface through a member of the tire, a centrifugal force applied to the power-generating vibration sensor is reduced, and a contact acceleration A_{c} is applied. In a state in which the tire further rotates and the power-generating vibration sensor moves away from the road surface, the member of the tire is opened from the road surface, a centrifugal force is thereby applied to the power-generating vibration sensor, and a release acceleration Aᵣ is applied.

The vibrating body of the power-generating vibration sensor is displaced due to the contact acceleration A_{c}, and performs free vibration. In this case, a contact power output P_{c} corresponding to the contact acceleration A_{c} is obtained. Subsequently, a centrifugal force is applied to the vibrating body again due to the release acceleration Aᵣ, free vibration is inhibited, and no power output is obtained.

The power output waveform illustrated in FIG. 11(a) is acquired, the contact power output P_{c} and a contact time period T_{c} are extracted, and thus an external vibration waveform including the contact acceleration A_{c}, the release acceleration Aᵣ, and the contact time period T_{c} that are illustrated in FIG. 11(b) can be obtained.

As described above, the power-generating vibration sensor enables an external vibration waveform to be obtained.

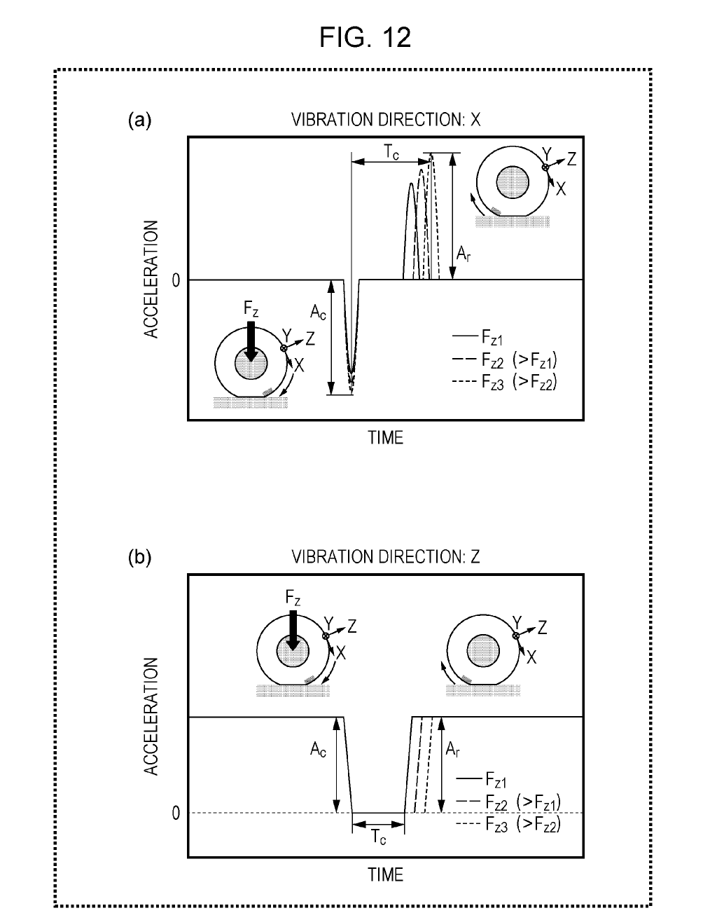

Next, a vibration data analysis method, and a tire or road surface condition estimation method will be described with reference to FIG. 12. In FIG. 12(a), the horizontal axis represents time, and the vertical axis represents an acceleration representing the magnitude of vibration in a tangential direction X of a round tire.

In a vehicle, a tire is deformed due to vehicle weight, an air pressure of the tire, or the like, and an area of contact between the tire and a road surface is changed. For example, in the case where the vehicle weight is heavy or the air pressure of the tire is low, the tire is deformed such that it is pressed flat in a road surface direction, and the area of contact between the tire and the road surface is increased. In FIG. 12(a), the amount of deformation of the tire is represented by using force F_{z} by which the tire is pressed against the road surface in a z direction perpendicular to the road surface. Increases in F_{z} from F_{z1} to F_{z2} and then to F_{z3} represent that the tire is firmly pressed against the road surface and the area of contact between the tire and the road surface is increased.

In the case where a speed is constant and the area of contact between the tire and the road surface is increased, the length of a contact time period T_{c} increases. In addition, since the tire is highly deformed, a contact acceleration A_{c} and a release acceleration Aᵣ increase.

These parameters are analyzed, and a tire condition or a road surface condition is thereby estimated. For example, in the case where a tire blowout occurs and the air pressure of the tire is reduced, since the tire is highly deformed, the length of the contact time period T_{c} increases, and the contact acceleration A_{c} and the release acceleration Aᵣ increase.

In addition, data of vibration in a normal direction Z of a round tire is also effective. In FIG. 12(b), the horizontal axis represents time, and the vertical axis represents an acceleration representing the magnitude of vibration in the normal direction Z of the round tire.

In the case where a speed is constant and an area of contact between the tire and a road surface is increased, the length of a contact time period T_{c} increases.

A tire or road surface condition estimation method is the same as that in the case of the above-mentioned tangential direction X.

As described above, the power-generating vibration sensor enables an estimation of a tire or road surface condition.

<3-2. Summary of Present Embodiment>

According to the tire or road surface condition estimation method of this present embodiment, the amount of deformation of a tire or a frictional force between the tire and a road surface is extracted from parameters, that is, a contact time period T_{c} from when the power-generating vibration sensor comes into contact with the road surface to when it moves away from the road surface due to rotation of the tire, a contact acceleration A_{c}, and a release acceleration Aᵣ, and thus a tire or road surface condition can be estimated.

The present structure enables, in a vehicle, warning display, an axle, and braking to be controlled in accordance with a tire or road surface condition.

### <4. Fourth Embodiment>

A fourth embodiment of the present disclosure will be described below.

In this present embodiment, a method of estimating a tire condition or a road surface condition by using a rotational speed of a tire will be described. Except for the above, the structure is the same as that in the third embodiment.

<4-1. Vibration Data Analysis Method, and Tire or Road Surface Condition Estimation Method>

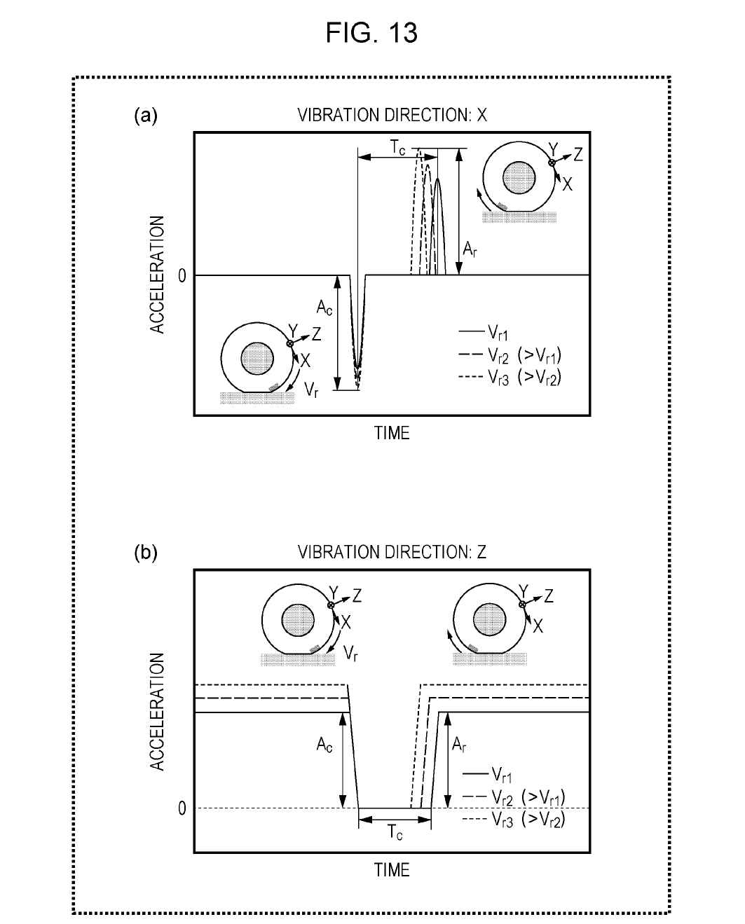

A vibration data analysis method, and a tire or road surface condition estimation method will be described with reference to FIG. 13. In FIG. 13(a), the horizontal axis represents time, and the vertical axis represents an acceleration representing the magnitude of vibration in a tangential direction X of a round tire.

In the case where a rotational speed Vr of the tire increases from Vᵣ₁ to Vᵣ₂ and then to Vᵣ₃, the length of a contact time period T_{c} decreases. In addition, a contact acceleration A_{c} and a release acceleration Aᵣ that are associated with deceleration and acceleration of the power-generating vibration sensor increase.

These parameters are analyzed, and a tire or road surface condition is thereby estimated. For example, in the case where the tire is worn and a frictional force between the tire and a road surface is reduced, or in the case of a slippery road surface, the tire spins freely and the rotational speed Vr of the tire increases. Because of this, the length of the contact time period T_{c} decreases, and the contact acceleration A_{c} and the release acceleration Aᵣ increase. In addition, in the case where a reduction in frictional force between the tire and the road surface is influential, the contact acceleration A_{c} and the release acceleration Aᵣ decrease.

In addition, data of vibration in a normal direction Z of a round tire is also effective. In FIG. 13(b), the horizontal axis represents time, and the vertical axis represents an acceleration representing the magnitude of vibration in the normal direction Z of the round tire.

In the case where the tire spins freely and a rotational speed Vr increases, since a centrifugal force applied to the power-generating vibration sensor is increased, the length of a contact time period T_{c} decreases, and a contact acceleration A_{c} and a release acceleration Aᵣ increase.

A tire or road surface condition estimation method is the same as that in the case of the above-mentioned tangential direction X.

As described above, the power-generating vibration sensor enables an estimation of a tire or road surface condition.

<4-2. Summary of Present Embodiment>

According to the tire or road surface condition estimation method of this present embodiment, a rotational speed of a tire or a frictional force between the tire and a road surface is extracted from parameters, that is, a contact time period T_{c} from when the power-generating vibration sensor comes into contact with the road surface to when it moves away from the road surface due to rotation of the tire, a contact acceleration A_{c}, and a release acceleration Aᵣ, and thus a tire or road surface condition can be estimated.

The present structure enables, in a vehicle, warning display, an axle, and braking to be controlled in accordance with a tire or road surface condition.

### <5. Other Embodiments>

The idea of the present disclosure is not limited to the above-mentioned embodiments. Other embodiments will be described below.

In the above-mentioned embodiments, the tire sensor system may have a data table in which vibration information and its corresponding tire and road surface conditions are listed. A tire or road surface condition is determined by checking actually measured vibration information against the data table.

Also, in the tire sensor system, vibration information may be specified in a protocol. The structure of information can be simplified, and the speeds of communication and information processing can be increased.

In addition, power outputs from two systems of the first electrodes 102 or 1002 and the second electrodes 104 or 1024 that are included in the power-generating vibration sensor 100 or 1000 are used for power generation and vibration detection; however, one system of the first electrodes 102 or 1002 may be provided and branch off at a subsequent stage so as to be used for power generation and vibration detection.

Furthermore, the movable substrate 110 of the power-generating vibration sensor 100 or 1000 vibrates, for example, in a direction of the double-headed arrow illustrated in FIG. 4. However, this is not intended to exclude vibration in a direction other than this double-headed arrow direction. The power-generating vibration sensor 100 or 1000 is mounted on the underside of the tire 310 so that a direction of external vibration coincides with a vibration direction of the movable substrate 110 of the power-generating vibration sensor 100 or 1000, and thus the external vibration can be utilized.

### <6. Summary>

The above-mentioned embodiments disclose ideas of the following power-generating vibration sensor and tire sensor system.

A first aspect provides a power-generating vibration sensor including: a power generation device that converts vibration into power and outputs vibration information; a first power system that extracts the output vibration information; and a second power system that is connected to the power generation device and supplies the power to a transmitter for transmitting the vibration information extracted by the first power system.

A second aspect provides the power-generating vibration sensor according to the first aspect, wherein the power generation device comprises two or more power generation devices, and the first power system is connected to at least one of the two or more power generation devices, and wherein the second power system is connected to at least one of remaining power generation devices of the two or more power generation devices.

A third aspect provides the power-generating vibration sensor according to the first or second aspect, wherein the first power system and the second power system are connected to the same power generation devices.

A fourth aspect provides the power-generating vibration sensor according to any of the first to third aspects, wherein the power generation device includes: a fixed substrate; a movable substrate that has one main surface facing one main surface of the fixed substrate and can vibrate in a direction substantially parallel to the fixed substrate; a plurality of electrets that are arranged, on one of the one main surface of the fixed substrate and the one main surface of the movable substrate, in parallel to a vibration direction of the movable substrate; and first electrodes and second electrodes that are arranged, on another of the one main surface of the fixed substrate and the one main surface of the movable substrate, in parallel to the vibration direction and in an alternating manner, and that are connected to either the first power system or the second power system.

A fifth aspect provides the power-generating vibration sensor according to any of the first to third aspects, wherein the power generation device includes: an elastic structure that can bend periodically and repeatedly; a fixed substrate that is connected to one end of the elastic structure; a movable substrate that is connected to another end of the elastic structure; and a first stacked structure and a second stacked structure that are provided on the elastic structure and connected to either the first power system or the second power system, wherein the first stacked structure has a first lower electrode, a first piezoelectric body formed on the first lower electrode, and a first upper electrode formed on the first piezoelectric body, and wherein the second stacked structure has a second lower electrode, a second piezoelectric body formed on the second lower electrode, and a second upper electrode formed on the second piezoelectric body.

A sixth aspect provides a tire including the power-generating vibration sensor that is mounted on an inner wall of the tire, wherein the tire estimates a condition of the tire and a condition of a road surface, from a power waveform obtained by the power-generating vibration sensor when the power-generating vibration sensor reaches ground, and a power waveform obtained when the power-generating vibration sensor moves away from the ground.

A seventh aspect provides an electrical device including the power-generating vibration sensor.

A eighth aspect provides a tire sensor system that monitors a condition of a tire or a road surface by using physical information of tire surroundings and performs safety control of a vehicle, wherein a sensor is arranged on an underside of the tire, and the tire sensor system estimates a condition of the tire or the road surface, from first vibration applied to the sensor in a state in which the sensor comes into contact with the road surface through a member of the tire due to rotation of the tire, second vibration applied to the sensor in a state in which the sensor moves away from the road surface, and a contact time period from when the sensor comes into contact with the road surface to when the sensor moves away from the road surface.

In the tire sensor system, the condition of the tire or the road surface may be an air pressure of the tire or a frictional force between the tire and the road surface.

In the tire sensor system, in a case where an air pressure of the tire is reduced, in vibration in a tangential direction of the tire which is round in shape, the first vibration and the second vibration may increase in magnitude, and length of the contact time period may increase.

In the tire sensor system, in a case where an air pressure of the tire is reduced, in vibration in a normal direction of the tire which is round in shape, length of the contact time period may increase.

In the tire sensor system, in a case where the tire easily slides, in vibration in the tangential direction of the tire which is round in shape, the first vibration and the second vibration may increase in magnitude, and the length of the contact time period may decrease.

In the tire sensor system, in a case where the tire easily slides and a reduction in a frictional force between the tire and the road surface is influential, in vibration in the tangential direction of the tire which is round in shape, the first vibration and the second vibration may decrease in magnitude, and the length of the contact time period may decrease.

In the tire sensor system, in a case where the tire easily slides, in vibration in the normal direction of the tire which is round in shape, the first vibration and the second vibration may increase in magnitude, and the length of the contact time period may decrease.

In the tire sensor system, a data table in which vibration information and conditions of a tire and a road surface corresponding to the vibration information are listed may be included, and a condition of the tire or the road surface may be determined by checking actually measured vibration information against the data table.

In the tire sensor system, the vibration information may be specified in a protocol, and communication or information processing may be performed.

In the tire sensor system, the vibration information may be obtained from a power-generating vibration sensor that extracts vibration information by using a power output waveform.

The present disclosure is useful as a tire sensor system that monitors a tire or road surface condition by using physical information of tire surroundings and performs safety control of a vehicle.

What is claimed is:

1. A power-generating vibration sensor comprising:
a power generation device that converts vibration into power and outputs vibration information;
a first power system that extracts the output vibration information; and
a second power system that is connected to the power generation device and supplies the power to a transmitter for transmitting the vibration information extracted by the first power system.

2. The power-generating vibration sensor according to claim 1,
wherein the power generation device comprises two or more power generation devices, and the first power system is connected to at least one of the two or more power generation devices, and
wherein the second power system is connected to at least one of remaining power generation devices of the two or more power generation devices.

3. The power-generating vibration sensor according to claim 1,
wherein the first power system and the second power system are connected to the same power generation device.

4. The power-generating vibration sensor according to claim 1,
wherein the power generation device includes:
a fixed substrate;
a movable substrate that has one main surface facing one main surface of the fixed substrate and can vibrate in a direction substantially parallel to the fixed substrate;
a plurality of electrets that are arranged, on one of the one main surface of the fixed substrate and the one main surface of the movable substrate, in parallel to a vibration direction of the movable substrate; and
first electrodes and second electrodes that are arranged, on the other of the one main surface of the fixed substrate and the one main surface of the movable substrate, in parallel to the vibration direction and in an alternating manner, and that are connected to either the first power system or the second power system.

5. The power-generating vibration sensor according to claim 1,
wherein the power generation device includes:
an elastic structure that can bend periodically and repeatedly;
a fixed substrate that is connected to one end of the elastic structure;
a movable substrate that is connected to another end of the elastic structure; and
a first stacked structure and a second stacked structure that are provided on the elastic structure and connected to either the first power system or the second power system,
wherein the first stacked structure has a first lower electrode, a first piezoelectric body formed on the first lower electrode, and a first upper electrode formed on the first piezoelectric body, and
wherein the second stacked structure has a second lower electrode, a second piezoelectric body formed on the second lower electrode, and a second upper electrode formed on the second piezoelectric body.

6. A tire comprising the power-generating vibration sensor according to claim 1 that is mounted on an inner wall of the tire,
wherein the tire estimates a condition of the tire and a condition of a road surface, from a power waveform obtained by the power-generating vibration sensor when the power-generating vibration sensor reaches ground, and a power waveform obtained when the power-generating vibration sensor moves away from the ground.

7. An electrical device comprising the power-generating vibration sensor according to claim 1.
